(19) United States
(12) Patent Application Publication
(10) Pub. No.: US 2026/0264648 A1
(43) Pub. Date: Sep. 10, 2026

(54) BRAKING SYSTEM COMPRISING A PARKING BRAKING DEVICE WITH INCREASED OPERATIONAL RELIABILITY

(71) Applicants: Hitachi Astemo France, Drancy (FR); HITACHI ASTEMO HEILBRONN GmbH, Helibronn (DE)

(72) Inventors: Julien SASSO, Champs Sur Mame (FR); Weiqiao WANG, Paris (FR); Alex PATRAO CARQUEIJO, Pantin (FR); Maxime DEMANDRE, Stuttgart (DE); Jéröme GARCIN, Bärjols (FR); Romaine HURE, Orleans (FR); Christopher CORDONNIER, Epinay Sur Seine (FR)

(21) Appl. No.: 19/132,597

(22) PCT Filed: Nov. 28, 2023
(86) PCT No.: PCT/EP2023/083391

§ 371 Date: May 23, 2025

(30) Foreign Application Priority Data
Nov. 30, 2022 (FR) 2212590

(51) Int. Cl. B60T 8/172; B60T 8/171; B60T 13/74

(52) U.S. Cl. CPC B60T 8/172; B60T 8/171; B60T 13/746; B60T 2270/402; B60T 2270/406

(57) ABSTRACT

The invention relates to a braking system comprising a parking brake device for a motor vehicle, which braking system comprises at least a first electrically actuated parking brake (FP I) intended to be positioned at a first wheel, a second electrically actuated parking brake (FP2) intended to be positioned at a second wheel, a control unit (UC) configured to generate an instruction for the first and second parking brakes (FPI, FP2) to apply a given parking braking force, and means (DI, D2) for determining the operating state of each of the first and second electric parking brakes (FP I, FP2), the control unit (UC) also being configured, during a malfunction of the first parking brake, to generate an instruction for the second parking brake (FP2) to apply at least the given parking braking force to ensure that the motor vehicle is immobilized.

### TECHNICAL FIELD AND PRIOR ART

The present invention relates to a braking system including a parking braking device for a motor vehicle and to a method of operation of such a braking system.

Motor vehicles are equipped with a braking system with a brake at each wheel.

The braking system provides service braking, which allows the vehicle to be slowed down and stopped. Service braking is generally obtained by depressing a brake pedal. The service braking can be controlled automatically by a control unit, e.g. in the case where automatic speed regulation is desired.

The braking system also provides parking braking, which is intended for immobilizing the vehicle when the vehicle is parked. The parking brake can also be used as an emergency brake. According to the regulations ECE R 13-H, the parking brake system must keep the loaded vehicle immobile on an 8% slope.

Generally, the braking system includes a parking brake on each rear wheel. Generally, the parking brake is integrated into the service brake.

Until recently, the parking brake was actuated by the driver pulling on a brake lever connected directly to the rear wheel brakes by a cable, the greater the traction, the greater the level of parking braking.

Increasingly frequently, the parking brake is actuated by pressing a button which sends a signal to the control unit which activates electric motors located at the rear wheels. The electric motor ensures that the brake pads are pressed against a brake disc in the case of a disc brake, or that the brake linings are pressed against a drum in the case of a drum brake.

When one of the two electric parking brakes is faulty, the other electric parking brake is deactivated and the driver is informed that the parking brake system is malfunctioning. However, the result is that the vehicle can no longer be immobilized.

### SUMMARY OF THE INVENTION

Therefore, a goal of the present application is to propose a parking braking system providing increase operational safety.

The goals stated hereinabove is achieved by a parking braking system including at least two electric parking brakes, one being intended to equip one of the rear wheels, and the other being intended to equip the other rear wheel, a control unit for the electric parking brakes, a sensor for the state of each of the electric parking brakes, the control unit being configured to compare the state of operation of each of the electric parking brakes during a parking braking phase and to adapt the operation of one of the electric parking brakes according to the operation of the other electric parking brake, so as the vehicle is kept immobile.

In one operating mode, in the event of a malfunction of one of the electric parking brakes, the other electric parking brake is controlled to at least partially compensate for the failure of the electric parking brake.

To this end, the braking level on the functional electric parking brake is increased.

Such braking system can then be used to comply with the regulations ECE R 13-H.

In one configuration, the failure appears while the other electric parking brake is going to be activated or is being activated, in which case the activation orders are modified during activation so that the braking level takes the failure into account.

In another configuration, the fault appears while the other electric parking brake is already in the applied state, in which case a new activation phase of the other electric parking brake is initiated to take account of the failure

In other words, a parking braking system is proposed wherein each parking brake can be activated separately while taking into account the state of operation of the other parking brake(s), which makes it possible to ensure the immobilization function of the motor vehicle despite the failure of the other parking brake(s).

A subject matter of the present invention is then a braking system including a parking braking device for a motor vehicle including at least a first electrically actuated parking brake intended to be positioned at a first wheel, a second electrically actuated parking brake intended to be positioned at a second wheel, a control unit configured to generate an order to the first and second parking brakes to apply a given parking braking force, means for determining the state of operation of each of the first and second electric parking brakes, the control unit also being configured, during a malfunction of the first parking brake, to generate an order to the second parking brake to apply at least said parking braking force, given for ensuring the immobilization of the motor vehicle.

In an example of embodiment, the control unit is configured, during a malfunction of the first parking brake, to generate an order to the second parking brake to apply an additional parking braking force on top of the given parking braking force.

According to an additional characteristic, the control unit can be configured, during a malfunction of the first parking brake, during a phase of electrical power supply of the second brake, to extend the electrical power supply of the second parking brake so that same applies an additional parking braking force on top of the given parking braking force.

According to another additional feature, the control unit is configured, during a malfunction of the first parking brake after the end of an electrical power supply phase of the second brake, to supply power to the second parking brake again, so that same applies an additional parking braking force on top of the given parking braking force.

For example, the means of determination the state of operation of each of the first and second electric parking brakes include means of measurement of the power supply current of the electric motor and/or a sensor for detecting the position of a movable element connected to a motor reduction gear of each of the first and second electric parking brakes.

Another subject matter of the present invention is a braking system including a parking braking system according to the invention and at least two service brakes, the parking brakes being integrated into the service brakes.

Another subject matter of the present invention is a method of operating a parking braking system including at least a first electrically actuated parking brake intended to be positioned at a first wheel, a second electrically actuated parking brake intended to be positioned at a second wheel and a control unit connected to the parking brakes and means of determination of the state of operation of each of the first and second electric parking brakes, said including the steps of:
a) generation by the control unit of an order to each of the parking brakes to apply a braking force apt to ensure the immobilization of the vehicle,
b) detection of the malfunction of the first parking brake,
c) generation, by the control unit, of an order to the second parking brake to apply a parking braking force.

In an example of operation, during step c), the second parking brake is controlled to increase the braking force same exerts on the wheel, to a determined value.

The operating method may advantageously include a step of determining the immobilization value by the control unit on the basis of information on the parking state of the motor vehicle.

The determination step may comprise taking into account the braking force applied by the first parking brake in a state of malfunction.

The operating method may advantageously include the generation, by the control unit, of a message to the driver informing him/her of the malfunction of the first parking brake.

### BRIEF DESCRIPTION OF FIGURES

The following description will be better understood with reference to the enclosed drawings, wherein:

FIG. 1 is a representation of a braking system according to an example of embodiment,

FIGS. 2A and 2B are graphical representations of the variation in power supply current of the electric parking brake and the resulting variation in the brake application force for both parking brakes in a first operating configuration,

FIGS. 3A and 3B are graphical representations of the variation in power supply current of the electric parking brake and the resulting variation in the brake application force for both parking brakes in a second operating configuration.

### DETAILED DESCRIPTION OF EMBODIMENTS

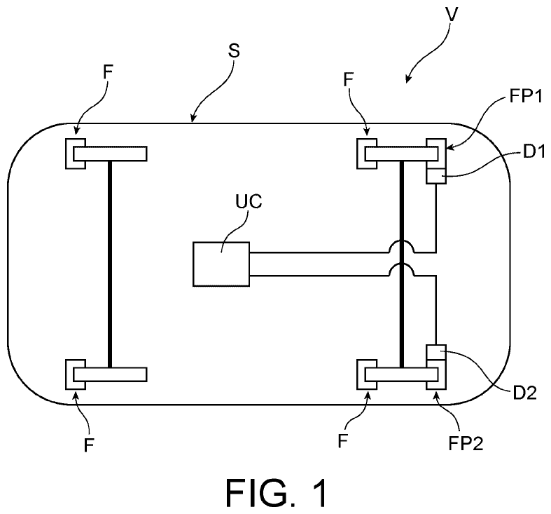

FIG. 1 shows a vehicle V, represented schematically, including a braking system comprising brakes F fitted to each wheel.

Hydraulic brakes generally provide service braking.

The braking system further includes a parking braking device including a first parking brake FP1 at the rear right wheel and a second parking brake FP2 at the rear left wheel.

The parking brakes FP1 and FP2 are electric parking brakes.

Generally, the parking brake is integrated into the service brake.

In the case of a disc brake, a motor reduction gear is integrated into the brake and ensures the displacement of the piston, e.g. by means of a screw-nut system.

In the case of a drum brake, a motor reduction gear fastened on the plate ensures the application of the linings against the drum, e.g. by means of a screw-nut system.

When the parking braking system includes two parking brakes, same are generally arranged to act on the two wheels of the same axle.

It is common for only the rear wheels to be equipped with parking brakes.

A braking system with four parking brakes and/or an electric service braking system does not depart from the scope of the present application.

The braking system further includes a control unit UC intended for controlling in particular the actuation of the electric parking brakes FP1 and FP2.

Indeed, the electric parking brakes are actuated either by a command of the driver by actuating a button, generally in the form of a small lever, or any other means of control, e.g. a voice command, or automatically, e.g. upon stopping the engine. The signal is detected by the control unit which sends an order to the motor reduction gear of each parking brake FP1, FP2 to apply a braking force. The intensity of the applied braking force depends on the slope on which the vehicle is parked. To this end, the braking system receives information on the parking state of the vehicle, in particular on the inclination of the vehicle.

Furthermore, the braking system includes means D1 and D2 for detecting the state of operation of each of the parking brakes FP1 and FP2, respectively. For example, the means measure the level of application of the brake on the disk or on the drum. The state of operation is determined e.g. through knowledge of the braking level, which can be obtained by measuring the power supply current of the electric motor which increases as the braking force increases. In a variant, the means of determination include a position sensor of a mobile element connected to the geared motor, e.g. a position sensor of the screw on the nut.

According to the invention, the control unit is further configured to be able to take into account the state of operation of one of the parking brakes FP1, FP2 in order to control the other parking brake FP2, FP1, respectively and ensure the immobilization of the vehicle.

The control unit is informed of the failure of one of the parking brakes FP1 and FP2 and sends orders to the other parking brake so that same at least partially compensates for the failure.

In the present application, the term “faulty parking brake” means a parking brake which cannot apply any braking force to the wheel on which same is fitted, or else a braking force which is less than the force required for the parking state of the vehicle. The failure may be mechanical and/or electrical and/or electronic.

We will explain two operating configuration modes of a parking braking system according to the invention.

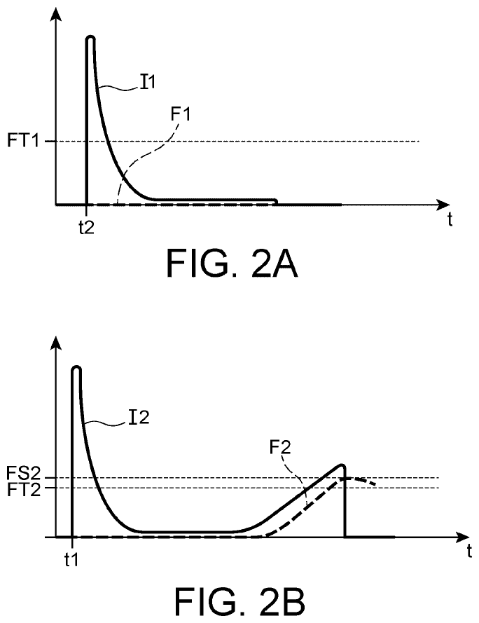

FIGS. 2A and 2B show a graphical representation of a first example of the operation of the parking braking system.

FIG. 2A shows the variation in the power supply current of the electric parking brake FP1 motor, denoted by 11 as a function of time and the variation in the application force F1 applied by the parking brake FP1 as a function of time.

FIG. 2B shows the variation in the power supply current of the electric parking brake FP2 motor, denoted by 12 as a function of time t and the variation in the application force F2 applied by the parking brake FP2 as a function of time t.

On each of the graphs is represented the braking force to be reached calculated in normal operation, denoted by FT1, FT2 for the brake FP1 and the brake FP2, respectively. The braking force to be achieved was determined by the control unit UC according to the parking situation. Generally, FT1 is equal to FT2.

The control unit sends an instruction to apply parking braking to both brakes FP1, FP2, which are then supplied with current.

In the present example, the current supply to brake FP2 starts at t1 before same to brake FP1 which starts at t2.

The first current peak corresponds to a peak at which the electric motor starts and clearances are taken up, in particular between the gears of the electric motor, the screw-nut system and the brake pad.

For brake FP1, no brake application force F1 is generated. Brake FP1 is considered to be faulty. Such absence of braking force results e.g. from a malfunction of the electric motor, and/or a malfunction in the screw-nut system, and/or a problem with the electric power supply.

For the brake FP2, the current supply I2 leads to the generation of a brake application force represented by the appearance of a second current peak which corresponds to a phase of force generation by the contact between the brake pad and the disc.

The control unit detects the malfunction of the brake FP1 and simultaneously modifies the instructions to the brake FP2 so that the braking force applied by same takes into account the malfunction of the brake FP1 and at least partially compensates for the malfunction. The electric motor of the brake FP2 is then supplied longer with current I2 so that the brake application force reaches a value FS2, ensuring the immobilization of the vehicle as if both parking brakes were functional.

The value FS2 is calculated by the control unit UC according to the parking state of the vehicle or is collected in a previously established database.

The parking brakes can be dimensioned so as to be able to each individually immobilize the loaded vehicle on a slope of up to 8%.

In another example of operation, the failure of the brake FP1 is simultaneous with the activation phase of the FP2 brake, which is followed by the correction of the activation order thereof. Thereby, the control unit is able to send two different successive orders to the same parking brake.

It should be noted that the current supply to the brake FP1 could have started before same to the brake FP2 without thereof changing the progress of the parking braking phase.

According to the invention, during a parking braking, the vehicle is immobilized as same would be if all parking brakes were functioning correctly. Preferably, provision is then made to send information to the driver about the malfunction of the parking braking system, and to have the parking braking system checked. Such information is e.g. in the form of a message or warning light display on the instrument panel and/or the emission of an audio message or signal. In an example of embodiment, it may be envisaged that the vehicle is immobilized following the detection of the failure of the brake FP1. For this purpose, e.g. the parking brake FP2 remains activated. The only way to deactivate the parking brake is by the intervention of a professional who informs the control unit.

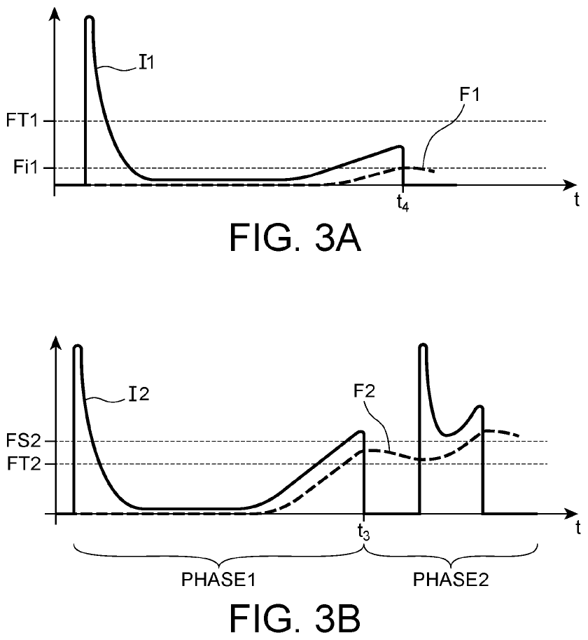

In FIGS. 3A and 3B, another mode of operation is shown wherein the detection of the failure of one of the parking brakes takes place while the other parking brake is already applied.

FIG. 3A shows the variation in the power supply current of the electric parking brake FP1 motor, denoted by 11 as a function of time and the variation in the application force F1 applied by the parking brake FP1 as a function of time.

FIG. 3B shows the variation in the power supply current of the electric parking brake FP2 motor, denoted by 12 as a function of time t and the variation in the application force F2 applied by the parking brake FP2 as a function of time t.

FIG. 3B shows a first operating phase of the brake FP2 to reach the braking force FT2 calculated by considering normal operation of the braking system. The first phase is denoted by PHASE 1. The braking force FT2 is reached at time t3. The supply with current I2 is interrupted. Indeed, when the control unit sends the instructions thereof, both parking brakes are considered to be operating normally.

In FIG. 3A, it can be seen that the brake application force of the brake FP1 is equal to Fi1 which is less than FT1 ordered by the control unit; the braking force FT1 has been calculated considering normal operation of the brake of the parking brake system. The braking force Fi1 is detected e.g. by measuring the current of the electric motor which is less than the current required to reach the braking force FT1. The brake FP1 is then considered to be faulty. Such absence of braking force results e.g. from a malfunction of the electric motor, and/or a malfunction in the screw-nut system, and/or a problem with the power supply The braking force Fi1 is detected at time t4, subsequent to time t3.

The control unit then generates a new command order to brake FP2 to adjust the braking level thereof to the failure of brake FP1. The new command order triggers a second phase of operation PHASE2. The electric motor of the brake FP2 is again supplied with current I2.

In one example, the control unit does not take Fi1 into account, considering that the brake FP1 is faulty, it is no longer reliable, which provides maximum safety.

In another example, when the brake FP2 is further activated, the braking force to be applied takes into account the residual force Fi1 applied by the brake FP1.

The electric motor of the brake FP2 is activated again and the braking force applied by the brake FP2 reaches the value FS2 ensuring the safe immobilization of the vehicle.

Preferably, the control unit sends information to the driver on the faulty state of the parking braking system, e.g. by displaying a message or warning light on the instrument panel and/or emitting an audio message or signal. In one example of embodiment, a message may be sent to an organization providing repair and/or maintenance services for motor vehicles.

In the examples described, the functional parking brake is controlled so that same compensates for the malfunction of the other parking brake. A braking system wherein the functional parking brake is controlled to ensure a safe immobilization of the vehicle and to make possible the repair thereof falls within the scope of the present invention. For example, the control unit controls the functional parking brake so that same provides a braking identical to the braking same would have provided if the other brake had been functional. Nevertheless, the parking brake system ensures the immobilization of the vehicle, unlike the parking brake systems of the prior art.

In the case of a parking brake system including four parking brakes, the control unit is configured to control the parking brakes so as to at least partially compensate for the malfunction of one or two parking brakes.

In an embodiment wherein the parking braking took place normally with an activation of both parking brakes, it can be envisaged that the control unit performs checks on the braking situation of each of the parking brakes in order to check whether one does not malfunction, and act on the other parking brake accordingly.

The present invention has the advantage of significantly increasing the safety level of the parking brake system by integrating the risk of failure of one of the electric parking brakes.

### REFERENCES

F: brake
FP1: first electric parking brake
FP2: second electric parking brake
D1: means of determination of the state of operation of the first parking brake,
D2: means of determination of the state of operation of the second parking brake,
F1: brake application force applied by the first parking brake
F2: brake application force applied by the second parking brake
FT1: braking force to be reached in normal operation by the first parking brake,
FT2: braking force to be reached in normal operation by the second parking brake
Fi1: braking force actually applied by the first parking brake
FS2: braking force ensuring the immobilization, applied by the second parking brake
I1, I2: power supply current
PHASE 1: first phase of operation
PHASE 2: second phase of operation
S: braking system
CPU: Control unit
V: Vehicle

1. A braking system including a parking braking device for a motor vehicle including at least a first electrically actuated parking brake intended to be positioned at a first wheel, a second electrically actuated parking brake intended to be positioned at a second wheel, a control unit configured to generate an order to the first and second parking brakes to apply a given parking brake force, and devices for determining a state of operation of each of the first and second electric parking brakes, the control unit being further configured, during a malfunction of the first parking brake, to generate the order to the second parking brake to apply at least said given parking braking force to ensure the immobilization of the motor vehicle.

2. The parking braking system according to claim 1, wherein the control unit is configured, during the malfunction of the first parking brake, to generate an additional order to the second parking brake to apply an additional parking brake force in addition to the given parking brake force.

3. The parking braking system according to claim 1, wherein the control unit (UC) is configured, during the malfunction of the first parking brake, during an electric power supply phase of the second brake to extend the electric power supply of the second parking brake to apply an additional parking brake force on top of the given parking brake force.

4. The parking braking system according to claim 1, wherein the control unit is configured, during the malfunction of the first parking brake, after the end of an electrical power supply phase of the second brake, to supply power to the second parking brake to apply an additional parking braking force in addition to the given parking braking force.

5. The parking braking system according to claim 1, wherein the devices for determining the state of operation of each of the first and second electric parking brakes include a sensor for measuring a power supply current of an electric motor or a sensor for detecting the position of a movable element connected to a motor reduction gear of each of the first and second electric parking brakes.

6. A braking system including a parking braking device for a motor vehicle including at least a first electrically actuated parking brake intended to be positioned at a first wheel, a second electrically actuated parking brake intended to be positioned at a second wheel, a control unit configured to generate an order to the first and second parking brakes to apply a given parking brake force, and devices for determining a state of operation of each of the first and second electric parking brakes, the control unit being further configured, during a malfunction of the first parking brake, to generate the order to the second parking brake to apply at least said given parking braking force to ensure the immobilization of the motor vehicle, and including and at least two service brakes, the first and second parking brakes being integrated into the service brakes.

7. A method for operating a parking braking system including at least a first electrically actuated parking brake intended to be positioned at a first wheel, a second electrically actuated parking brake intended to be positioned at a second wheel and a control unit connected to the parking brakes and to devices for determining a state of operation of each of the first and second electric parking brakes, said including the steps of:
a) generation by the control unit of an order to each of the parking brakes to apply a braking force apt to ensure the immobilization of the vehicle,
b) detection of the malfunction of the first parking brake,
c) generation, by the control unit, of an additional order to the second parking brake to apply the parking braking force.

8. The operating method according to claim 7, wherein during step c) the second parking brake is controlled to increase the braking force same exerts on the wheel to a predetermined value.

9. The operating method according to claim 8, including a step of determining an immobilization value by the control unit on the basis of information on a parking state of the motor vehicle.

10. The operating method according to claim 9, wherein the determination step comprises taking into account a braking force applied by the first parking brake in the state of malfunction.

11. The operating method according to claim 8, including generation, by the control unit, of a message to a driver informing him/her of the malfunction of the first parking brake.

12. The parking braking system according to claim 1, wherein the control unit is configured, during the malfunction of the first parking brake, after the end of an electrical power supply phase of the second brake, to supply power to the second parking brake to apply an additional parking braking force in addition to the given parking braking force.

13. The parking braking system according to claim 2, wherein the control unit is configured, during the malfunction of the first parking brake, after the end of an electrical power supply phase of the second brake, to supply power to the second parking brake to apply an additional parking braking force in addition to the given parking braking force.

14. The parking braking system according to claim 3, wherein the control unit is configured, during the malfunction of the first parking brake, after the end of an electrical power supply phase of the second brake, to supply power to the second parking brake to apply an additional parking braking force in addition to the given parking braking force.

15. The parking braking system according to claim 2, wherein the devices for determining the state of operation of each of the first and second electric parking brakes include a sensor for measuring a power supply current of an electric motor or a sensor for detecting the position of a movable element connected to a motor reduction gear of each of the first and second electric parking brakes.

16. The parking braking system according to claim 3, wherein the devices for determining the state of operation of each of the first and second electric parking brakes include a sensor for measuring a power supply current of an electric motor or a sensor for detecting the position of a movable element connected to a motor reduction gear of each of the first and second electric parking brakes.

17. The parking braking system according to claim 4, wherein the devices for determining the state of operation of each of the first and second electric parking brakes include a sensor for measuring a power supply current of an electric motor or a sensor for detecting the position of a movable element connected to a motor reduction gear of each of the first and second electric parking brakes.

18. The parking braking system according to claim 5, wherein the devices for determining the state of operation of each of the first and second electric parking brakes include a sensor for measuring a power supply current of an electric motor or a sensor for detecting the position of a movable element connected to a motor reduction gear of each of the first and second electric parking brakes.

19. The parking braking system according to claim 6, wherein the devices for determining the state of operation of each of the first and second electric parking brakes include a sensor for measuring a power supply current of an electric motor or a sensor for detecting the position of a movable element connected to a motor reduction gear of each of the first and second electric parking brakes.

20. The parking braking system according to claim 7, wherein the devices for determining the state of operation of each of the first and second electric parking brakes include a sensor for measuring a power supply current of an electric motor or a sensor for detecting the position of a movable element connected to a motor reduction gear of each of the first and second electric parking brakes.
